(19) United States
(12) Patent Application Publication
(10) Pub. No.: US 2016/0086031 A1
(43) Pub. Date: Mar. 24, 2016

(54) IMAGE PROCESSING APPARATUS, IMAGE PROCESSING METHOD, AND STORAGE MEDIUM

(71) Applicant: FUJITSU LIMITED, Kawasaki-shi (JP)

(72) Inventors: Shinji Shigeno, Oita (JP); Teruo Shimomura, Oita (JP); Kozo Baba, Oita (JP)

(73) Assignee: FUJITSU LIMITED, Kawasaki-shi (JP)

(21) Appl. No.: 14/959,853

(22) Filed: Dec. 4, 2015

Related U.S. Application Data
(63) Continuation of application No. PCT/JP2013/067155, filed on Jun. 17, 2013.

(51) Int. Cl. G06K 9/00; G06K 9/62

(52) U.S. Cl. CPC G06K 9/00624; G06K 9/6202

(57) ABSTRACT

An image processing apparatus includes a processor that executes a process. The process includes converting an input image into multiple types of images based on values of pixels in the input image, and selecting at least one image from the multiple types of images based on luminance information of the multiple types of images.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2013/067155, filed on Jun. 17, 2013, the entire contents of which are incorporated herein by reference.

### FIELD

An aspect of this disclosure relates to an image processing apparatus, an image processing method, and a storage medium.

### BACKGROUND

There exists a method where an image including a recognition object such as a meter installed in a location is captured by an operator, and the meter in the captured image is recognized to read values displayed on the meter. There also exists a method where an identification marker is attached to a recognition object so that the location of the recognition object in a captured image can be identified, and an image area of the recognition object is obtained based on the position of the identification marker in the captured image (see, for example, Japanese Laid-Open Patent Publication No. 2002-056371).

### SUMMARY

According to an aspect of this disclosure, there is provided an image processing apparatus including a processor that executes a process. The process includes converting an input image into multiple types of images based on values of pixels in the input image, and selecting at least one image from the multiple types of images based on luminance information of the multiple types of images.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an image processing apparatus;

FIG. 2 is a block diagram illustrating an exemplary hardware configuration of an image processing apparatus;

FIG. 3 is a flowchart illustrating an exemplary process performed by an image processing apparatus;

FIG. 4 is a drawing used to describe an exemplary process performed by a projective transformer;

FIG. 5 is a flowchart illustrating an exemplary process performed by an image processor;

FIGS. 6A through 6G are drawings illustrating exemplary images on which a channel evaluation process is performed;

FIGS. 7A and 7B are drawings illustrating exemplary component images obtained by a channel separation process;

FIG. 8 is a drawing illustrating an exemplary image of a 7-segment digit;

FIGS. 9A and 9B are drawings used to describe exemplary boundary enhancement processes;

FIG. 10 is a drawing used to describe exemplary image processing according to a first embodiment; and

FIG. 11 is a drawing used to describe exemplary image processing according to a second embodiment.

### DESCRIPTION OF EMBODIMENTS

When, for example, an image including a recognition object installed in an outdoor location is captured, the color of the entire image may be influenced by outdoor light, and a light source (e.g., the sun or a flash of a camera) may be reflected in a part of the image. This in turn makes it difficult to recognize the recognition object in the image.

Also, when, for example, an image of a meter is captured, the easiness of reading values of the meter in the image varies depending on the degree of influence of outside light and the type of the meter. Therefore, simply correcting the luminance (or intensity) of the image does not make it easier to recognize values of the meter in the image.

An aspect of this disclosure provides an image processing apparatus, an image processing method, and a storage medium that make it possible to convert a captured image into an image suitable for recognition processing.

Embodiments of the present invention are described below with reference to the accompanying drawings.

### <Functional Configuration of Image Processing Apparatus>

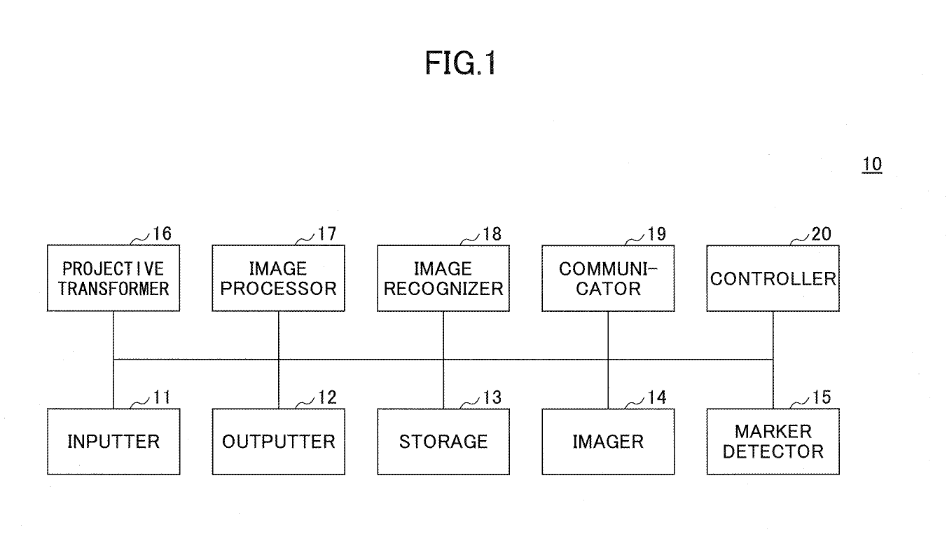

FIG. 1 is a block diagram illustrating an exemplary functional configuration of an image processing apparatus 10 according to an embodiment. As illustrated by FIG. 1, the image processing apparatus may include an inputter 11, an outputter 12, a storage 13, an imager 14, a marker detector 15, a projective transformer 16, an image processor 17, an image recognizer 18, a communicator 19, and a controller 20.

The inputter 11 receives various inputs such as settings and requests (or instructions) to start and stop processes from, for example, a user of the image processing apparatus 10. For example, the inputter 11 receives a capture request, a marker detection request, a projective transformation request, an image optimization request, and an image recognition request.

The inputter 11 may be implemented by, for example, a keyboard, a mouse, a touch panel, and/or a microphone.

The outputter 12 outputs, for example, information input via the inputter 11 and results of a process executed based on input information. For example, the outputter 12 may include a display unit such as a display or a monitor for displaying information and/or an audio output unit such as a speaker for outputting audio. The outputter 12 may also be implemented by a touch panel. Further, the inputter 11 and the outputter 12 may be implemented by a single device such as a touch panel.

The storage 13 stores various types of information used in the present embodiment. For example, the storage 13 stores input information received from the inputter 11, image information received from the imager 14, image information received via the communicator 19 from an external apparatus, and image processing results of the present embodiment. The storage 13 may also store various types of setting information used for image processing of the present embodiment, and information indicating the progress and results of various processes. Types of information stored in the storage 13 are not limited to those described above.

Under the control by, for example, the controller 20, the storage 13 reads and writes information as necessary at specified timing. The storage 13 may be implemented by, for example, a hard disk drive or a memory.

The imager 14 captures images including recognition objects such as meters installed in various locations. The imager 14 captures images based on predetermined capturing conditions defined by imaging parameters such as an image size, an image resolution, use of a flash, and a zoom ratio. The imager 14 is, for example, but is not limited to, a digital camera.

One or more markers may be attached to a recognition object to be captured by the imager 14 so that the position of the recognition object in a captured image can be identified. As a non-limiting example, a marker is a point or an area whose color or luminance (intensity) is greatly different from that of a background. For example, a marker may be implemented by a predetermined pattern or mark (e.g., a quadrangle, a triangle, or a star shape), or may be implemented by a combination of multiple shapes.

When, for example, an area of a meter displaying values has a rectangular shape, markers may be attached to the four corners of the rectangular area. As another example, when a meter has a circular shape, markers may be attached to four points arranged at regular intervals along the circumference of the meter. When multiple markers are used for a meter, the markers may not necessarily be the same type. For example, at least one of the marks may be different from the other marks so that the orientation of the meter in a captured image can be identified. An image captured by the imager 14 may be stored in the storage 13 or may be directly input to the marker detector 15.

The marker detector 15 detects positions of markers in an image that includes a recognition object and is captured by the imager 14 or received via the communicator 19 from an external apparatus. For example, when an image captured by the imager 14 is a color image, the marker detector 15 converts the color image into a binary image. As an example, the marker detector 15 binarizes the color image by using marker color information set for markers. That is, the marker detector 15 sets pixels having approximate colors close to the marker color information at 1 and sets pixels having other colors at 0. Here, colors within a predetermined deviation from the marker color information are determined to be the approximate colors. The marker color information may be represented by, but is not limited to, brightness or luminance (intensity). Also, binarization of an image may be performed by any other appropriate method. For example, pixels having the approximate colors may be set at 0 and pixels having other colors may be set at 1.

The marker detector 15 may also be configured to perform noise removal. The marker detector 15 may be configured to remove binarization noise by performing dilation and erosion on a binary image. Here, “dilation” indicates a process where a target pixel is changed to white when at least one white pixel exists around the target pixel. On the other hand, “erosion” indicates a process where a target pixel is changed to black when at least one black pixel exists around the target pixel. Alternatively, the marker detector 15 may be configured to remove noise by performing a smoothing process on an image before binarization.

The marker detector 15 also extracts marker areas. For example, the maker detector 15 extracts one or more marker areas by performing a labeling process on a noise-removed binary image. The marker detector 15 may be configured to report “Marker Not Found” to a user when a predetermined number of marker areas (e.g., four marker areas) are not extracted.

Further, the marker detector 15 obtains marker positions (coordinates) of the extracted marker areas. For example, the marker detector 15 obtains the center position of each marker area as the marker position. The marker position may be represented by, but is not limited to, coordinates (x, y) in a two-dimensional coordinate system set for an image.

The projective transformer 16 performs projective transformation to transform marker positions (four points) in a captured image obtained by the marker detector 15 to positions of predetermined four points. As a non-limiting example, the projective transformer 16 may be configured to calculate a homography matrix based on the marker positions (e.g., four points) and the positions of the predetermined four points, and to perform projective transformation on the captured image using the calculated homography matrix. The projective transformer 16 performs projective transformation on an area (marker-surrounded area) of an image surrounded by marker areas to generate an image (projectively-transformed image) of the marker-surrounded area. Performing the projective transformation makes it possible to obtain a front-view image of a recognition object even when marker areas in a captured image are tilted or the recognition object is not captured from the front side.

The image processor 17 corrects (or optimizes) an image transformed by the projective transformer 16 into an image suitable for image recognition. For example, the image processor 17 converts an image transformed by the projective transformer 16 into multiple types of images (channel images) based on values of pixels. Also, the image processor 17 selects at least one of the multiple types of images based on a predetermined criterion (e.g., a luminance difference or a luminance variance) related to luminance information of the images. In the descriptions below, a process performed by the image processor 17 may be referred to as an “optimization process”.

The image processor 17 may also be configured to select and optimize an image based on at least one of the type of a recognition object, a captured time, capturing conditions (e.g., use of a flash, surrounding brightness, and availability of an automatic gain function of a camera), and a captured location. Details of the image processor 17 are described later.

The image recognizer 18 recognizes at least one of a value, a character, a symbol, and a shape (e.g., a shape or a position of a needle of an analog meter) in an image optimized by the image processor 17. For example, when a recognition object is a digital meter that displays each digit with seven segments (7-segment display) as in a display of a calculator, the image recognizer 10 recognizes a value of the digit. As another example, when a recognition object is an analog meter that indicates a value by the position of a needle on a dial, the image recognizer 18 recognizes the shape (or position) of the needle. Information items recognized by the image recognizer 18 are not limited to the above examples.

The image recognizer 18 may be configured to recognize a numeral or a character in an image by using an optical character recognition (OCR) technique, or to recognize a numeral, a character, or a shape in an image by comparison with pre-stored numerals, characters, or shapes.

The communicator 19 is a transceiver that sends and receives information to and from an external apparatus via a communication network such as the Internet or a local area network (LAN). The communicator 19 can receive information stored in an external apparatus and send processing results of the image processing apparatus 10 to an external apparatus.

The controller 20 controls other components of the image processing apparatus 10. More specifically, the controller 20 performs various control processes related to image processing based on, for example, instructions entered via the inputter 11 by a user. Examples of control processes include causing the imager 14 to capture a recognition object (e.g., a meter), causing the marker detector 15 to detect markers, causing the projective transformer 16 to perform projective transformation, causing the image processor 17 to optimize an image, and causing the image recognizer 18 to recognize an image.

The image processing apparatus 10 may be, but is not limited to, a communication terminal such as a tablet computer, a smartphone, or a cell phone. The image processing apparatus 10 may also be implemented by a personal computer (PC) or a server that obtains an image captured by an external apparatus such as a camera via the communicator 19 and performs image processing on the image according to the present embodiment. In this case, the imager 14 may be omitted from the image processing apparatus 10. Further, the image processing apparatus 10 may be implemented by a digital camera (imaging device) or a game machine.

With the above described configuration, the image processing apparatus 10 can convert images of various types of meters captured under various lighting conditions into images suitable for recognition processing.

### <Hardware Configuration of Image Processing Apparatus>

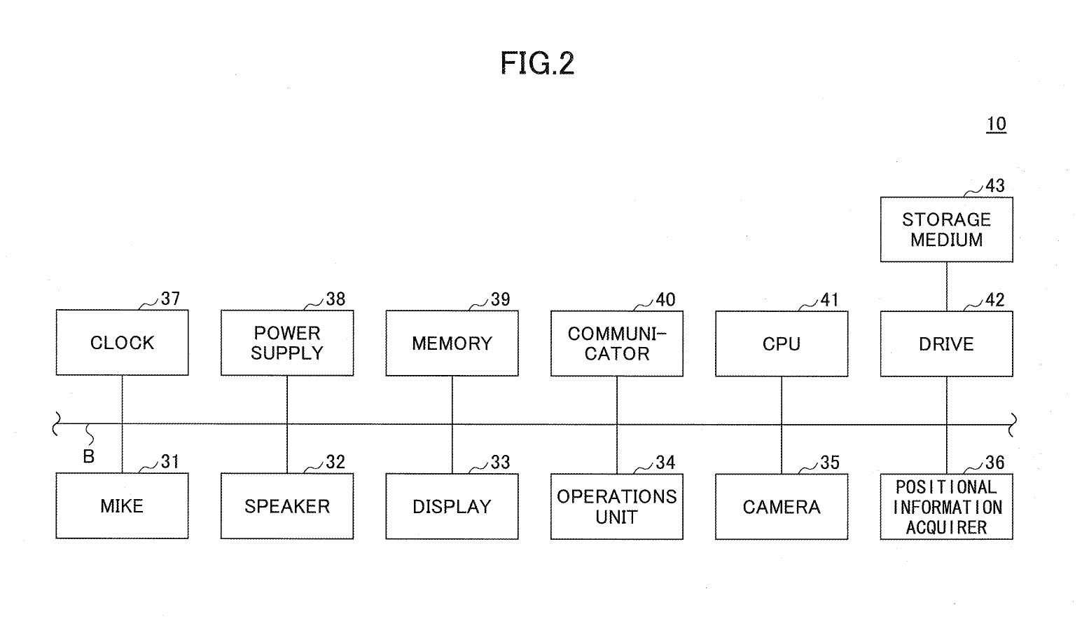

FIG. 2 is a block diagram illustrating an exemplary hardware configuration of the image processing apparatus 10. In the example of FIG. 2, it is assumed that the image processing apparatus 10 is a communication terminal such as a tablet computer. As illustrated by FIG. 2, the image processing apparatus 10 may include a microphone (MIKE) 31, a speaker 32, a display 33, an operations unit 34, a camera 35, a positional information acquirer 36, a clock 37, a power supply 38, a memory 39, a communicator 40, a central processing unit (CPU) 41, and a drive 42 that are connected to each other via a system bus B.

The mike 31 inputs voice uttered by a user and other sounds. The speaker 32 outputs voice of a communication partner and other sounds such as ringtone. The mike 31 and the speaker 32 may be used to talk with a communication partner using a call function, and may also be used to input and output information via audio.

The display 33 may be implemented by, for example, a liquid crystal display (LCD) or an organic electroluminescence (EL) display. Also, the display 33 may be implemented by a touch panel display including a display and a touch panel.

The operations unit 34 may be implemented by, for example, icons and buttons displayed on a touch panel or operation buttons provided on the image processing apparatus 10. Examples of the operation buttons may include, but are not limited to, a power button, a capture button, and a volume control button. The operations unit 34 receives various instructions and information from a user.

The camera 35 captures recognition objects being managed by, for example, an operator. The camera 35 may be included in the image processing apparatus 10, or may be provided as an external device that is connected directly or indirectly (e.g., wirelessly or via a communication line) to the image processing apparatus 10 and configured to send captured data to the image processing apparatus 10.

The positional information acquirer 36 obtains positional information (e.g., a latitude and a longitude) of the image processing apparatus 10 using, for example, a global positioning system (GPS) function. The positional information may be used, for example, to determine the location where an image is captured by the camera 35. The positional information may also be obtained using technologies other than the GPS. For example, when the image processing apparatus 10 is configured to perform near-field communications based on Wireless Fidelity (Wi-Fi (registered trademark)), the positional information acquirer 36 may obtain positional information of the image processing apparatus 10 based on positional information of access points. Also, the positional information acquirer 36 may be configured to obtain an inclination, an angle, and an orientation of the image processing apparatus 10 using, for example, an acceleration sensor and a gyro sensor of the image processing apparatus 10.

When the camera 35 is provided as an external device connected directly or indirectly to the image processing apparatus 10, the positional information acquirer 36 is preferably provided in the camera 35 to obtain information on a location where an image is captured.

The clock 37 obtains a time. The clock 37 may be configured to also obtain a date (year, month, day) and may include a function as a timer. The time obtained by the clock 37 may be used, for example, to determine when an image is captured by the camera 35.

The power supply 38 supplies power to other components of the image processing apparatus 10. The power supply 38 is, for example, but is not limited to, an internal power source such as a battery. The power supply 38 may be configured to also monitor its remaining energy level by detecting the energy level continuously or at predetermined intervals.

The memory 39 may be a main storage and/or a secondary storage. The memory 39 may be implemented by, for example, a read-only memory (ROM) and a random access memory (RAM). Also, the memory 39 may be implemented by a storage device such as a hard disk drive (HDD) or a solid state drive (SSD).

The memory 39 stores programs and data, and inputs and outputs programs and data as necessary. Also, the memory 39 may temporarily store execution programs read and executed by the CPU 41, and may also store information obtained during the execution of the programs.

The communicator 40 is a communication interface that, for example, receives a radio signal (communication data) via an antenna from a base station and sends a radio signal via the antenna to the base station. The communicator 40 may also be configured to perform near-field communications with an external device using a communication technology such as infrared communication, Wi-Fi (registered trademark), or Bluetooth (registered trademark).

The CPU 41 controls the entire image processing apparatus 10 (or a computer) according to control programs such as an OS and execution programs stored in the memory 39 to perform, for example, various calculations and data input/output between the CPU 41 and other hardware components, and thereby performs image processing. The CPU 41 may obtain information necessary for the execution of programs from the memory 39 and store execution results in the memory 39.

A storage medium 43 can be detachably set on the drive 42. The drive 43 can read and write information from and onto the set storage medium 43. The drive 42 is, for example, but is not limited to, a storage medium slot.

The storage medium 43 is a computer-readable storage medium storing, for example, execution programs. Examples of the storage medium 43 include, but are not limited to, a semiconductor memory such as a flash memory and a portable storage medium such as a Universal Serial Bus (USB) memory.

With the hardware configuration (hardware resources) as described above and installed execution programs (software resources) such as an image processing program, a computer (the image processing apparatus 10) can perform image processing of the present embodiment.

### <Exemplary Process Performed by Image Processing Apparatus>

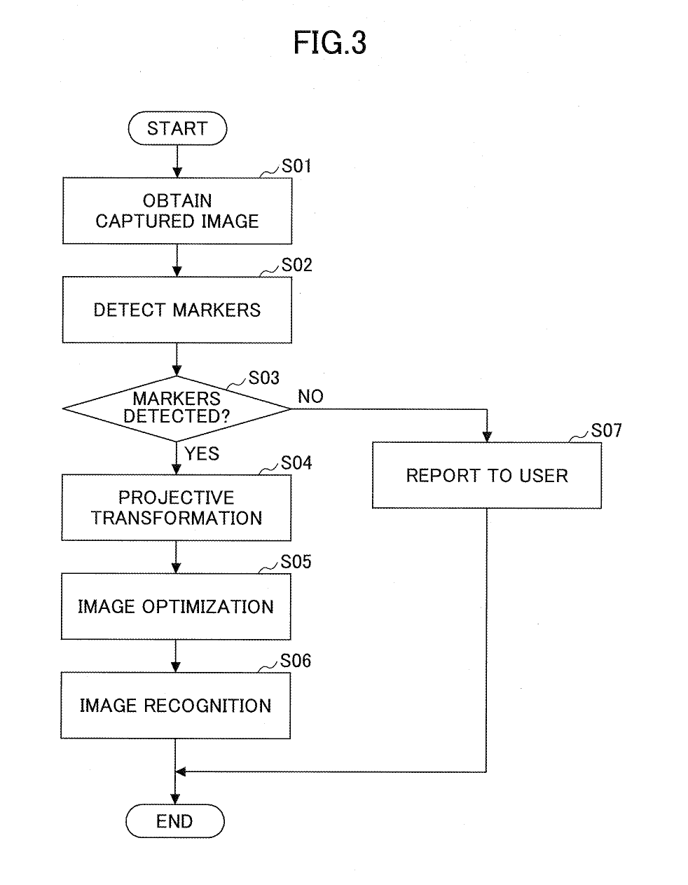

An exemplary process performed by the image processing apparatus 10 according to an image processing program of the present embodiment is described below. FIG. 3 is a flowchart illustrating an exemplary process performed by the image processing apparatus 10.

As illustrated by FIG. 3, the imager 14 of the image processing apparatus 10 captures an image (S01). Alternatively, at step S01, a captured image may be received from an external device via the communicator 19. Next, the marker detector 15 performs a marker detection process on the captured image (S02).

The marker detector 15 determines whether markers have been detected (S03). When the marker detector 15 determines that markers have been detected (YES at S03), the projective transformer 16 performs projective transformation on marker areas of the detected markers to generate a projectively-transformed image (S04).

Next, the image processor 17 performs an optimization process on the projectively-transformed image (S05). Then, the image recognizer 18 recognizes at least one of a value, a character, a symbol, a needle shape, and a needle position of a recognition object in an optimized image obtained as a result of step S05 (S06).

On the other hand, when the marker detector 15 determines that markers have not been detected (NO at S03), the image processing apparatus 10 reports to the user that markers have not been detected (S07), and ends the process. After reporting to the user at step S07, the image processing apparatus 10 may be configured to obtain another image captured by the user and repeat step S02 and subsequent steps.

### <Exemplary Process Performed by Projective Transformer>

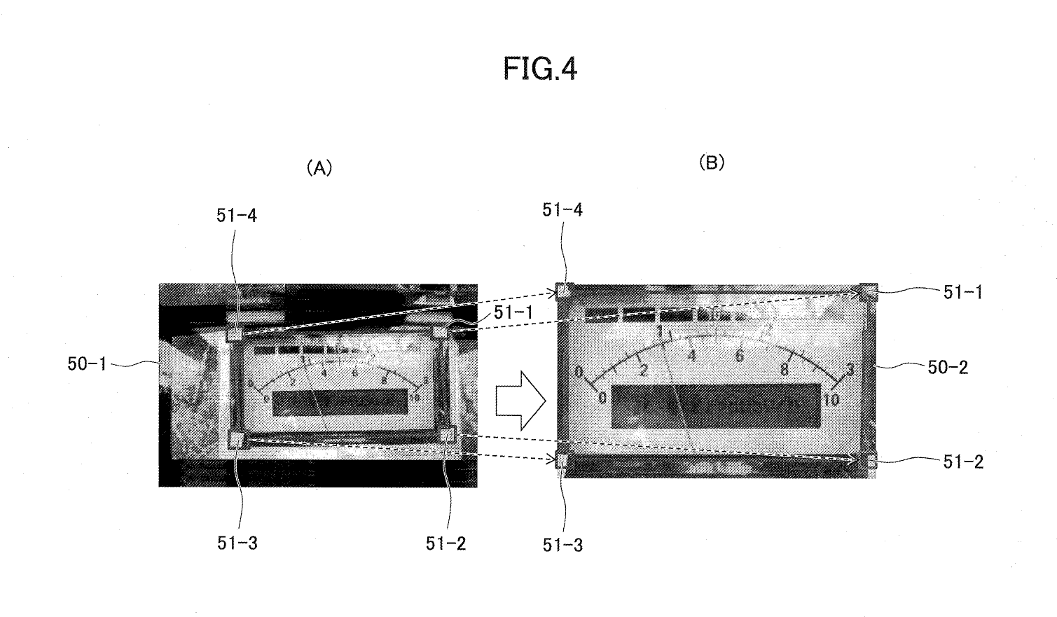

Next, an exemplary process performed by the projective transformer 16 is described. FIG. 4 is a drawing used to describe an exemplary process performed by the projective transformer 16. In FIG. 4, (A) indicates an example of a captured image 50-1, and (B) indicates an example of a projectively-transformed image 50-2.

The projective transformer 16 obtains the captured image 50-1 captured, for example, by the imager 14. In the example of FIG. 4, the captured image 50-1 includes an analog meter as a recognition object.

When an image including a meter is captured by a user (operator) using the imager 14, the meter in the captured image may become tilted or the meter may not be captured exactly from the front side. The projective transformer 16 normalizes (or corrects) such a captured image. In the example of FIG. 4, the projective transformer 16 transforms positions of markers 51-1 through 51-4 to positions of predetermined four points having a predetermined positional relationship (vertical and horizontal distances) to normalize the captured image 50-1 and obtain the projectively-transformed image 50-2.

As a non-limiting example, the projective transformer 16 may be configured to normalize an image by calculating a homography matrix based on marker positions (e.g., four points) and positions of predetermined four points, and performing projective transformation on the image using the calculated homography matrix.

### <Exemplary Process Performed by Image Processor>

Next, an exemplary process performed by the image processor 17 is described. The image processor 17 performs predetermined image processing on a projectively-transformed image to extract a detection target (e.g., a light emitting diode (LED) display displaying each digit with 7 segments, or a needle) and remove other parts of the projectively-transformed image.

For example, even when the same meter is captured, the characteristic of a captured image varies depending on capturing conditions (e.g., influence of a light source of a digital display, influence of surrounding brightness or outside light, and influence of an imaging parameter such as availability of an automatic gain function). To reduce effects of variation in image characteristics, the image processor 17 performs image processing as described below.

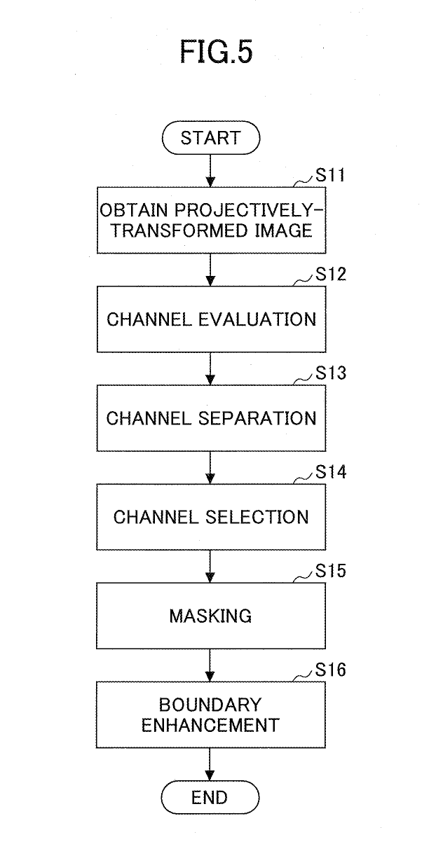

FIG. 5 is a flowchart illustrating an exemplary process performed by the image processor 17. As illustrated by FIG. 5, the image processor 17 obtains a projectively-transformed image from the projective transformer 16 (S11). Next, the image processor 17 converts the projectively-transformed image into channel images of respective channels (components) based on values of pixels in the projectively-transformed image, and performs a channel evaluation process using the channel images (S12). Here, “channels” indicate color components of pixels included in a color image obtained at step S11. Channels may include, but are not limited to, red (R), green (G), blue (B), hue (H), saturation (S), and intensity (I).

The image processor 17 evaluates, for example, luminance (intensity) information of the channel images, excludes unnecessary channel images based on the evaluation results, and optimizes remaining (necessary) channel images. For example, the image processor 17 performs a channel separation process to separate the projectively-transformed image into channel (component) images necessary for image optimization based on the evaluation results of step S12 (S13), and selects at least one channel image from the channel images (S14).

Next, the image processor 17 performs a masking process on the selected channel image (S15), and performs an optimization process such as boundary enhancement on an image obtained as a result of the masking process (S16). At step S16, in addition to or instead of boundary enhancement, binarization, brightness correction, or sharpness correction may be performed. Through the above process, the image processor 17 can perform image optimization of the present embodiment.

### <Channel Evaluation Process>

Next, the channel evaluation process performed at step S12 above is described in more detail. In the channel evaluation process, unnecessary channel (component) images in a projectively-transformed image are excluded from conversion targets (which are to be obtained by converting the projectively-transformed image) based on a predetermined criterion. This makes it possible to select only necessary channels and perform image optimization using the selected channels. Below, exemplary criteria and processes corresponding to the criteria are described.

### <Criterion 1>

For example, the image processor 17 converts an input image into an R-component image, a G-component image, and a B-component image as multiple types of images. Next, the image processor 17 sets a line of pixels in the input image, and obtains differences between (luminance values of) RGB components (i.e., a difference between R and G components, a difference between R and B components, and a difference between G and B components) of each pixel in the line. Also, the image processor 17 determines the largest difference in the differences obtained for each pixel, and extracts pixels the largest differences of which are greater than a predetermined value. Further, the image processor 17 obtains the number of extracted pixels in the line, and determines whether to convert the input image also into an H-component image, an S-component image, and an I-component image based on the number of extracted pixels. For example, the image processor 17 may be configured to exclude the H, S, and I component images from conversion targets when the number of extracted pixels is less than or equal to a threshold.

This is described in more detail below. According to a criterion 1, the image processor 17 obtains luminance values of pixels in a vertical or horizontal line set in an image. The direction and the number of lines are not limited to this example. Next, the image processor 17 obtains absolute values of differences between (luminance values of) RGB components of each pixel in the line, and compares the obtained values of all pixels in the line with a predetermined threshold (first threshold). The first threshold is, for example, but is not limited to, a threshold used to determine whether an image is close to monochrome. For example, when the obtained values are less than or equal to the first threshold (or when the number of pixels whose values are less than or equal to the first threshold is less than or equal to another threshold), the image processor 17 excludes the H-component image, the S-component image, and the I-component image from conversion targets, and determines to convert the input image only into the R-component image, the G-component image, and the B-component image.

### <Criterion 2>

For example, the image processor 17 obtains luminance values of R, G, and B components of each pixel in a line of pixels of an input image. Next, for each of the R, G, and B components, the image processor obtains a pixel count indicating the number of pixels whose luminance values of the corresponding component (one of the R, G, and B components) exceed a predetermine value. Then, based on the pixel counts of respective components, the image processor 17 determines a component image(s) that is excluded from conversion targets.

This is described in more detail below. According to a criterion 2, similarly to the criterion 1, the image processor 17 obtains luminance values of pixels in a vertical or horizontal line set in an image. Next, for each of the R, G, and B components (channels), the image processor 17 counts the number of pixels (pixel count) whose luminance values of the corresponding component are greater than or equal to a predetermined threshold (second threshold). Then, the image processor 17 compares the pixel counts of the R, G, and B components with each other, and excludes a component image(s) (one or more of the R, G, and B component images) corresponding to a component(s) with the higher or highest pixel count(s). The second threshold is, for example, but is not limited to, a threshold used to determine whether the luminance of a particular component of each pixel in a line is saturated. Through the above process, the image processor 17 excludes one or more of the R, G, and B component images with the higher or highest pixel counts from conversion targets, and converts an input image into component images other than the excluded component images. The image processor 17 may also be configured to compare the pixel counts of the R, G, and B component images with another threshold, and to exclude one or more of the R, G, and B component images whose pixel counts are greater than or equal to the threshold. Also, according to the criterion 2, the H, S, and I component images may always be included in conversion targets.

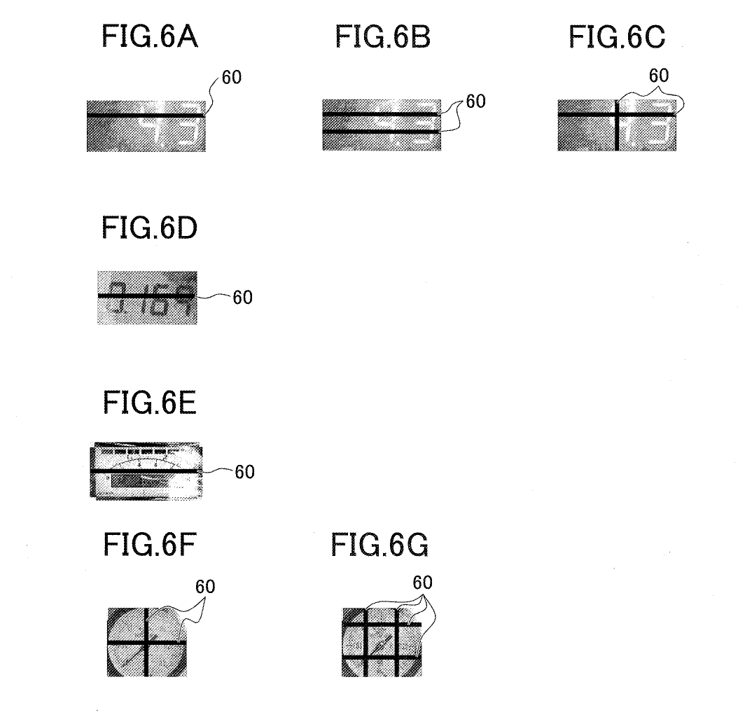

FIGS. 6A through 6G are drawings illustrating examples of projectively-transformed images on which a channel evaluation process is to be performed. FIGS. 6A through 6D are images of a digital display meter, and FIGS. 6E through 6G are images of an analog display meter.

The positions and the number of lines used for the above-described channel evaluation process may be predetermined, or may be determined based on at least one of the criteria including the type of a recognition object in an input image, a captured time, a captured location, and an imaging parameter. Also, lines may be set based on the shape of an area (marker-surrounded area) of a captured recognition object, the color of markers, the size of markers, and/or the influence of outside light.

In the examples of FIGS. 6A and 6D where digital numbers are displayed, one horizontal line 60 used for channel evaluation is set to pass through segment parts (where segments representing numbers are displayed) and non-segment parts (parts other than the segment parts).

As illustrated by FIG. 6B, the image processor 17 may be configured to set multiple horizontal lines 60 passing through segment parts and non-segment parts to improve the stability of channel evaluation. Also, taking into account the influence of, for example, a flash of the imager 14, the image processor 17 may be configured to set one vertical line 60 in addition to the horizontal line 60 as illustrated by FIG. 6C. The vertical line 60 is preferably set near or at the center of an image because the reflection of flash light generally enters in the middle of an image. Also, multiple vertical lines 60 may be set in an image.

In the example of FIG. 6E where an analog meter (which includes a needle whose range of movement is less than 180 degrees) is captured, one horizontal line 60 that passes through the needle may be set. Also in this case, the image processor 17 may be configured to set a vertical line in addition to the horizontal line 60 taking into account the influence of a flash of the imager 14. When the needle of a meter is small, the image processor 17 may be configured to set two or more horizontal lines arranged in a vertical direction to reduce noise in the channel evaluation process.

In the example of FIG. 6F where an analog meter (which includes a needle whose range of movement is greater than or equal to 180 degrees) is captured, two lines 60 that cross each other and pass through the center of the image may be set so that the rotational center of the needle can be determined. Also, the image processor 17 may be configured to set two vertical lines 60 and two horizontal lines 60 as illustrated by FIG. 6G so that the needle crosses at least one of the lines 60 at any position.

The image processor 17 obtains luminance values of respective components (channels) of each pixel on the line(s) 60 exemplified in FIGS. 6A through 6G, and excludes one or more of the components from conversion targets based on the luminance values. For example, in the case of FIGS. 6A through 6C, the R component has a high luminance level and there are large luminance differences between the R component and the G and B components. In this case, because the R component is saturated, the R-component image is excluded from conversion targets.

In the case of FIG. 6D, there are only small differences between the R, G, and B components, and therefore none of the R, G, and B component images is excluded from conversion targets. In the case of FIG. 6E, there is a difference between every combination of the R, G, and B components, and each of the R, G, and B component images includes a high-luminance area. Therefore, in this case, none of the R, G, and B component images is excluded from conversion targets.

Criteria for excluding unnecessary component (channel) images are not limited to the criterion 1 and the criterion 2 described above, and the image processor 17 may be configured to use any appropriate criterion to exclude unnecessary component images. Also, the image processor 17 may be configured to convert an input image into all of the R, G, B, H, S, and I component images.

### <Channel Separation Process>

Next, the channel separation process performed at step S13 above is described in more detail. In the channel separation process, a projectively-transformed (normalized) image is separated (or converted) into component (channel) images that are determined as conversion targets by the channel evaluation process performed at step S12. For example, when all components (channels) are conversion targets, the image processor 17 converts an input image into R, G, B, H, S, and I component images. The number of components (channels) to be separated from an input image is not limited to the above example.

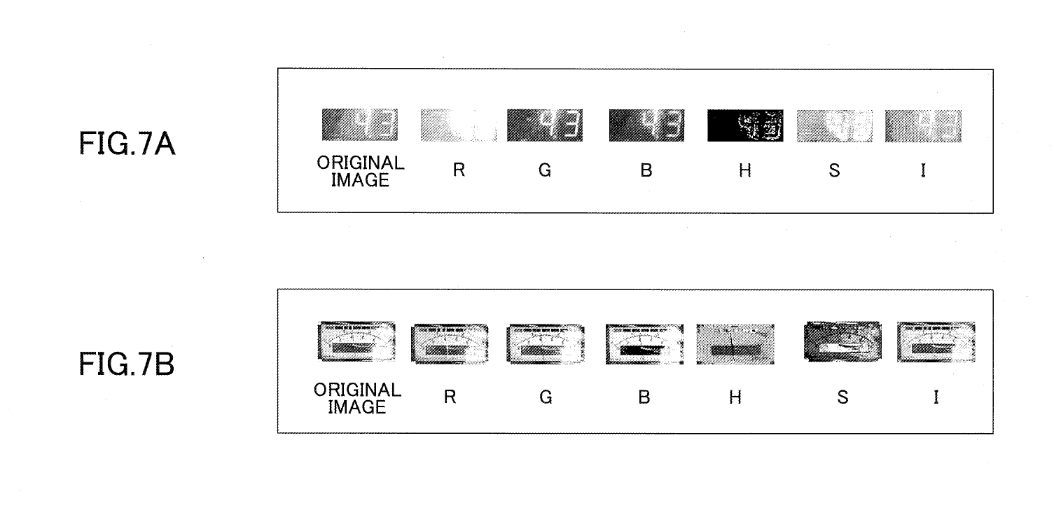

FIGS. 7A and 7B are drawings illustrating exemplary component images obtained by the channel separation process. FIG. 7A illustrates exemplary component images of a digital meter, and FIG. 7B illustrates exemplary component images of an analog meter. In each of the examples of FIGS. 7A and 7B, an original image (projectively-transformed image) is separated into R, G, B, H, S, and I component images. The image processor 17 can generate component images by performing a channel separation process on an original image.

### <Channel Selection Process>

Next, the channel selection process performed at step S14 above is described in more detail. The channel selection process is performed using different methods for a case (separate type) where detection parts (segment parts) and non-detection parts (non-segment parts) are separate from each other as in a digital meter, and for a case (overlapping type) where detection parts and non-detection parts overlap each other as in an analog meter.

### <Separate Type>

In a case where detection parts (segment parts) and non-detection parts (non-segment parts) are separate from each other in a projectively-transformed image as illustrated by FIG. 7A, the image processor 17 obtains a total luminance difference that is a sum of luminance differences between “n” detection parts and the corresponding non-detection parts in each of component (channel) images, and selects at least one of the component images that has the largest total luminance difference. For example, when three digits are included in the projectively-transformed image, the image processor 17 obtains luminance differences between 7×3=21 segment parts and the corresponding non-segment parts.

Here, when multiple images are determined as candidates, the image processor 17 may be configured to select one of the images whose non-detection parts have the smallest luminance variance.

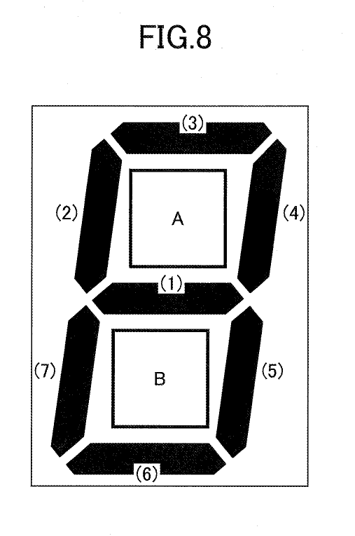

FIG. 8 is a drawing illustrating an exemplary image of a 7-segment digit represented by 7 segments. In the example of FIG. 8, areas A and B indicate non-detection parts (non-segment parts). In the 7 segments, a segment (1) indicates a center horizontal segment, a segment (2) indicates an upper-left vertical segment, a segment (3) indicates a top horizontal segment, a segment (4) indicates an upper-right vertical segment, a segment (5) indicates a lower-right vertical segment, a segment (6) indicates a bottom horizontal segment, and a segment (7) indicates a lower-left vertical segment.

The image processor 17 obtains luminance values of the areas A and B from the corresponding area images. These luminance values are, for example, average luminance values of the respective areas A and B. The image processor 17 obtains luminance differences between a luminance value of the segment (1) and an average luminance value of the areas A and B. Also, the image processor 17 obtains luminance differences between luminance values of the segments (2) through (4) and the luminance value of the area A. Further, the image processor 17 obtains luminance differences between luminance values of the segments (5) through (7) and the luminance value of the area B. In the case of the separate type, areas corresponding to detection parts and non-detection parts in an image may be set beforehand by, for example, a user, or may be set dynamically depending on the type of a recognition object such as a meter.

The image processor 17 obtains a total luminance difference that is a sum of the luminance differences of the respective segments obtained as described above for each of the R, G, B, H, S, and I component (channel) images, and selects one of the component images that has the largest total luminance difference. When there are multiple component images having the largest total luminance difference, the image processor 17 may be configured to select one of the component images whose areas A and B (non-histogram parts) have the smallest luminance variance (i.e., a component image including the areas A and B where the variation in luminance is smallest).

### <Overlapping Type>

In a case where detection parts and non-detection parts overlap each other in a projectively-transformed image as illustrated by FIG. 7B, the image processor 17 obtains a variance of luminance values of pixels for each of the R, G, B, H, S, and I component (channel) images, and selects one of the component images that has the smallest variance. As a non-limiting example, an overlapping type indicates a case where a needle (detection part) of an analog meter moving on a dial overlaps a scale and characters (non-detection parts) on the dial.

When obtaining variances of luminance as described above, the image processor 17 may be configured to generate luminance histograms based on luminance values, and to select a component image with the smallest variance based on the generated luminance histograms. The image processor 17 may also be configured to perform a channel selection process using images on which a masking process described later has been performed.

According to the above methods, the image processor 17 selects the G-component image in the example of FIG. 7A, and selects the H-component image in the example of FIG. 7B. In the above examples, the processes for the separate type and the overlapping type are performed on the R, G, B, H, S, and I component (channel) images. However, when one or more component images are excluded based on the results of the channel evaluation process, processes on the excluded component images can be omitted. This in turn makes it possible to increase the processing speed.

As described above, in the present embodiment, different channel selection methods are used for the separate type and the overlapping type. Therefore, the image processor 17 may be configured to allow a user to select one of the channel selection methods. Also, the image processor 17 may be configured to change channel selection methods or mask images based on, for example, the type (e.g., a digital meter or an analog meter) and/or the size of a meter to be captured. The type of a meter may be set, for example, by a user (operator), or the image processing apparatus 10 may be configured to recognize, for example, a product code in an image by character recognition, and identify the type of a meter based on the recognized product code.

Also, the image processor 17 may be configured to change a factor for brightness correction based on the time (e.g., day or night) when a recognition object is captured. Further, the image processor 17 may be configured to retain various thresholds adjusted to capturing locations (installation locations), and to select one of the thresholds corresponding to a location where a recognition object is actually captured. For example, when a recognition object including a 7-segment display, which tends to blur due to its high brightness, is captured at night, the image processor may select a component image with less blur for recognition.

### <Masking Process>

Next, the masking process performed at step S15 above is described in more detail. In the masking process, an AND operation is performed between a mask image and a captured image or a projectively-transformed image to mask unnecessary image areas. Different mask images are used depending on the types (e.g., shape and size) of recognition objects such as meters. The image processor 17 may be configured to store mask images corresponding to types (for example, identified by product codes) of recognition objects in the storage 13 beforehand, and to use one of the mask images corresponding to a type specified by, for example, a user. Also, the image processor 17 may be configured to recognize, for example, a product code of a recognition object in an image using an optical character recognition (OCR) technique, and to obtain a mask image corresponding to the recognized product code. Further, the image processor 17 may be configured to automatically generate a mask image based on, for example, a radius and a center of a meter obtained from an image.

The masking process described above makes it possible to remove unnecessary parts of an image and reduce noise, and thereby makes it possible to more appropriately optimize an image.

### <Boundary Enhancement Process>

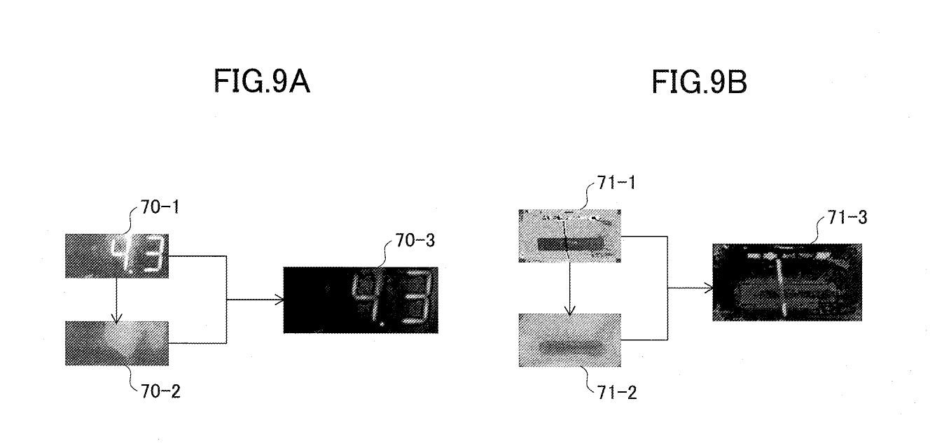

Next, the boundary enhancement process performed at step S16 above is described in more detail. FIGS. 9A and 9B are drawings used to describe exemplary boundary enhancement processes. FIG. 9A is a drawing used to describe an exemplary boundary enhancement process performed on an image of a digital meter, and FIG. 9B is a drawing used to describe an exemplary boundary enhancement process performed on an image of an analog meter.

In the example of FIG. 9A, it is likely that a G-component image 70-1 selected by the channel selection process is incorrectly detected due to noise caused by light (e.g., outside light) on a numeral “4”. For this reason, the image processor 17 performs a blurring process on the G-component image 70-1 to generate a blurred image 70-2, obtains absolute values of differences between the blurred image 70-2 and the G-component image 70-1, and obtains an enhanced image 70-3 suitable for recognition based on the obtained absolute values. In the enhanced image 70-3, the noise on the numeral “4” is not present. The blurring process may be using, for example, a smoothing filter, a median filter, or a Gaussian filter.

In the example of FIG. 9B, the image processor 17 performs a blurring process on an H-component image 71-1 to generate a blurred image 71-2, obtains absolute values of differences between the blurred image 71-2 and the H-component image 71-1, and obtains an enhanced image 71-3 where a needle of the meter is enhanced based on the obtained absolute values.

### <Other Examples of Optimization Processes>

Optimization processes of the present embodiment are intended to correct a projectively-transformed image to obtain an image suitable for image recognition (e.g., recognition of a meter). The optimization processes of the present invention are preferably performed on an image captured in an outdoor environment where the characteristic of the captured image tends to be influenced by, for example, outside light.

In addition to the optimization processes described above, a brightness correction process and a sharpness correction process may also be performed as optimization processes.

### <Brightness Correction Process>

For example, when “src” indicates a pre-optimization image and “dst” indicates a post-optimization image, a brightness correction process may be defined by a formula “dst=src×N₁+N₂”. In this formula, N₁ indicates a scaling factor and N₂ indicates an added value factor. As a non-limiting example, when a captured image of a recognition object such as a meter becomes dark due to the time when the image is captured, the image processor 17 can enhance luminance values 0 through 128 to luminance values 0 through 255 by setting N₁ at 2.0 and N₂ at 0 (in this case, when enhanced values become greater than or equal to 255, those values are set at 255).

### <Sharpness Correction Process>

In the sharpness correction process, the image processor 17 performs a filtering process using a 3×3 matrix where a sharpening factor N₃ is used.

For example, the sharpness correction process may be defined by a formula “dst=M×src(3, 3)” where M indicates a matrix defined by formula (1) below.

$$( \begin{matrix}- {N}_{3} / 9 & - {N}_{3} / 9 & - {N}_{3} / 9 \\ - {N}_{3} / 9 & 1 + 8 \times {N}_{3} / 9 & - {N}_{3} / 9 \\ - {N}_{3} / 9 & - {N}_{3} / 9 & - {N}_{3} / 9\end{matrix} ) \qquad ( 1 )$$

In formula (1), the sharpening factor N₃ may be set at any value greater than or equal to 1.0 (N3≧1.0) to enhance, for example, an edge. As the sharpening factor N₃ increases, the degree of edge enhancement increases.

Also, in the boundary enhancement process of step S16 described above, the image processor 17 may use a formula “dst=src×N₄+N₅” to perform scale conversion. In this formula, N₄ indicates a scaling factor and N₅ indicates an added value factor. For example, when absolute values of differences between an original image and a blurred image are obtained and an image is obtained based on the absolute values as described with reference to FIGS. 9A and 9B, the image becomes dark. In such as case, the image processor 17 may evenly enhance low-luminance parts of the image using this formula. The boundary enhancement process may be used, for example, in a case where differences between characters or numerals and a background are small.

### <How to Determine Factors Used in Optimization Processes>

According to the present embodiment, multiple combinations of factors used for the optimization processes may be prepared in advance, and one of the combinations may be selected based on at least one criterion related to a captured image. Examples of criteria may include, but are not limited to, the type of a recognition object (e.g., a meter), the installation location (positional information) of a meter, a captured time, the difference between the original color (known color) of a marker and a color (corrected color) detected from an image, and the edge intensity between a marker and a surrounding image.

The installation location of a meter may be set, for example, by a user in advance, or may be obtained by the positional information acquirer 36 of the image processing apparatus 10. Also, the captured time may be determined based on time information obtained from the clock 37 of the image processing apparatus 10.

### First Embodiment

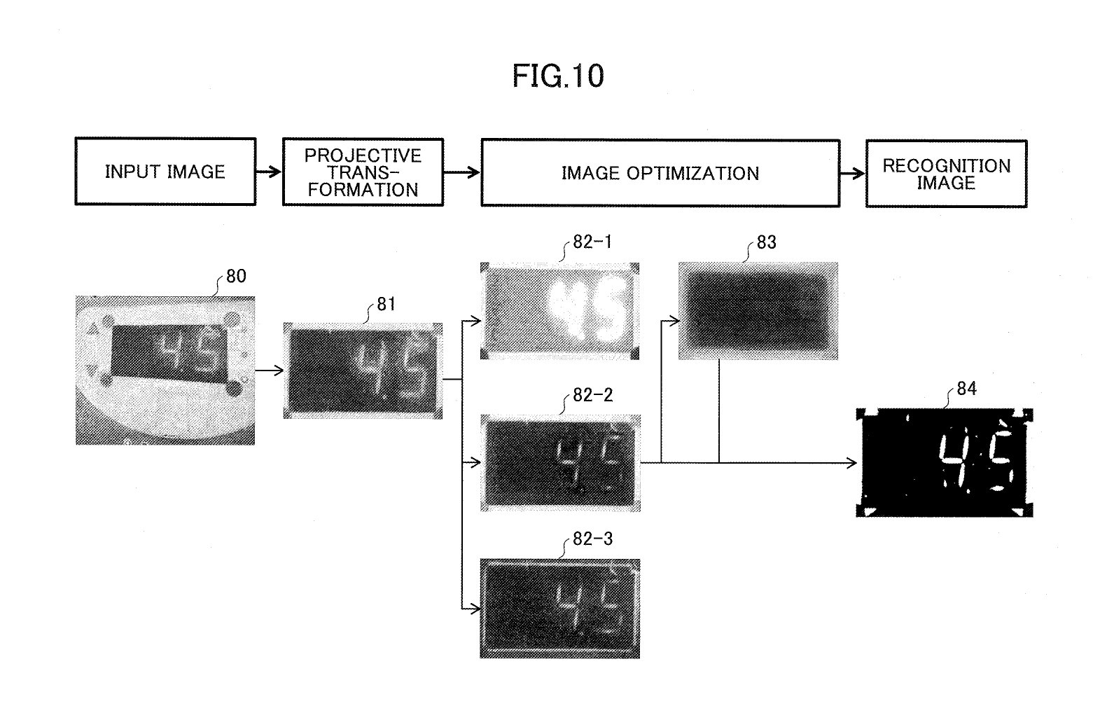

Next, exemplary image processing according to a first embodiment is described with reference to FIG. 10. FIG. 10 is a drawing used to describe exemplary image processing according to the first embodiment. In the example of FIG. 10, it is assumed that the recognition object is a digital meter. In the example of FIG. 10, the image processing apparatus 10 obtains an original image 80 captured by the imager 14, detects markers in the original image 80, and obtains a projectively-transformed image 81 extracted from a marker-surrounded area based on the positions of the detected markers.

Next, the image processor 17 of the image processing apparatus 10 performs the channel evaluation process described above on the projectively-transformed image 81 to obtain color component images 82-1 through 82-3, and performs the channel selection process on the color component images 82-1 through 82-3. In the channel selection process, a channel selection method may be selected based on, for example, a captured time, or may be dynamically selected based on, for example, an image obtained by binarizing an R-component image.

In the example of FIG. 10, the image 82-1 is an R-component image, the image 82-2 is a G-component image, and the image 82-3 is a B-component image. In FIG. 10, 7-segment digits that can be recognized by extracting the red color are displayed. However, when an image is captured at night, the red color in the image is blurred due to the influence of, for example, illuminating light and the automatic gain function, and it becomes difficult to recognize the digits. For this reason, in the example of FIG. 10, the G-component image 82-2 is selected by the channel selection process. In this case, the image processor 17 applies, for example, a median filter or a Gaussian filter to the G-component image 82-2 to generate a blurred image 83, obtains luminance differences between the blurred image 83 and the G-component image 82-2, and generates a recognition image 84 to be recognized by the image recognizer 18 based on the obtained luminance differences.

In the example of FIG. 10, only the G-component image 82-2 selected by the channel selection process is used. However, the present invention is not limited to this example. Instead, multiple recognition images may be generated using two or more component images, and a final recognition image may be generated by combining the multiple recognition images.

### Second Embodiment

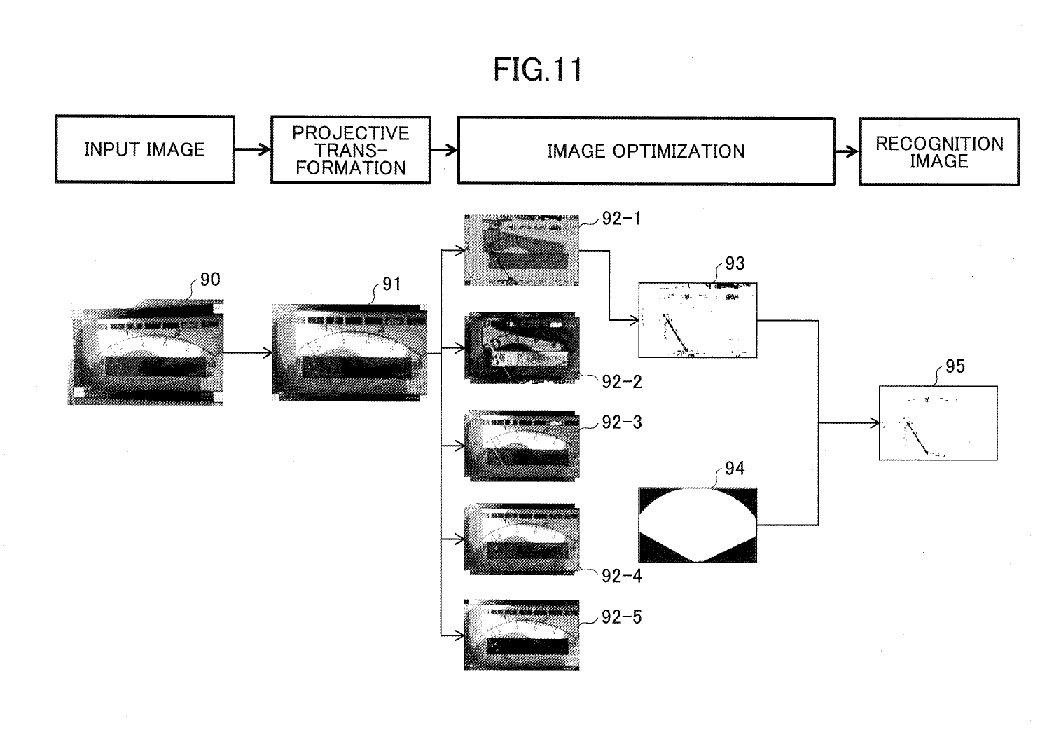

FIG. 11 is a drawing used to describe exemplary image processing according to a second embodiment. In the example of FIG. 11, it is assumed that the recognition object is an analog meter. In the example of FIG. 11, the image processing apparatus 10 obtains an original image 90 captured by the imager 14, detects markers in the original image 90, and obtains a projectively-transformed image 91 extracted from a marker-surrounded area based on the positions of the detected markers.

Next, the image processor 17 of the image processing apparatus 91 performs the channel evaluation process described above on the projectively-transformed image 91 to obtain color component images 92-1 through 92-5, and performs the channel selection process on the color component images 92-1 through 92-5. In the channel selection process, a channel selection method may be selected based on, for example, a captured time, or may be dynamically selected based on, for example, an image obtained by binarizing an R-component image.

In the example of FIG. 11, it is difficult to recognize the meter in the image due to sunlight and shade. In the optimization process of the present embodiment, an image is optimized to make it easier for the image forming apparatus 10 to recognize a meter, rather than to make it easier for a person to recognize the meter.

For example, the image processor 17 of the image processing apparatus 10 separates an input image into some of R, G, B, H, S, and I (red, green, blue, hue, saturation, and intensity) channels (components), and selects one or more of the channels to be used for image recognition. In the example of FIG. 11, the image 92-1 is an H-component image, the image 92-2 is an S-component image, the image 92-3 is an R-component image, the image 92-4 is a G-component image, and the image 92-5 is a B-component image.

In the example of FIG. 11, the image processor 17 selects the H-component image 92-1 through the channel selection process. In this case, the image processor 17 binarizes the H-component image 92-1 to generate a binary image 93 and combines the binary image 93 with a predefined mask image 94. As a non-limiting example, the mask image 94 may be selected from predefined multiple mask images based on the type of a meter. Also, the image processing apparatus 10 may be configured to automatically generate a mask image based on, for example, a radius and a center of a meter.

Through the above process, the image processor 17 generates a recognition image 95 to be recognized by the image recognizer 18. In the example of FIG. 11, only the H-component image 92-1 selected by the channel selection process is used. However, the present invention is not limited to this example. Instead, multiple recognition images may be generated using two or more component images, and a final recognition image may be generated by combining the multiple recognition images.

Although the shape of a needle is enhanced in the example of FIG. 11, a process to enhance numerals on the dial may also be performed. The image recognizer recognizes a value based on the position of the needle in the recognition image 95. For example, the image recognizer 18 may be configured to store the minimum value and the maximum value in a movement range of a needle for each type of a meter, and to recognize a value corresponding to the position of the needle in the movement range corresponding to the type of the meter in the recognition image 95.

In the above embodiments, a digital meter (with a 7-segment display) and an analog meter (with a needle) are used as examples of recognition objects for which recognition images are generated. However, the present invention is not limited to the above-described embodiments. For example, the present invention may also be applied to a digital display other than a 7-segment display and an analog display using a component other than a needle. Further, the above-described processes may be combined to recognize a meter including both a digital display and an analog display.

### <Applications>

Data recognized by the image recognizer 18 may be managed using a cloud computing system including one or more information processing apparatuses. For example, images of measurement devices such as a dosimeter and a temperature sensor installed in various locations may be captured and recognized, and information including measurement values indicated by the measurement devices, the installation locations of the measurement devices, and times when the images are captured may be obtained based on the recognition results and stored in a cloud computing system. This makes it possible to perform time-series analysis on the measurement values and obtain statistics of the measurement values.

In the above embodiments, it is assumed that an operator captures a recognition object using a terminal such as a smartphone or a digital camera. However, the present invention is not limited to the above embodiments. For example, an image may be obtained by capturing a recognition object at predetermined timing or intervals using a camera fixed in front of the recognition object, and the above-described image processing may be performed on the obtained image to recognize values in the image.

The image processing of the above embodiments may be executed by an application installed in a terminal. For example, an application may be configured to start a cyclic process after being activated and to capture an image once in each cycle, perform image processing on the captured image, and store recognition results in a file.

The image processing of the above embodiments may also be used to determine virus infection status based on color changes of a specimen as a reaction to a virus. For example, an image of a detection plate with markers is captured, the markers in the captured image are detected, the captured image is normalized (e.g., distortion correction) based on the detected markers, an appropriate color component image is extracted from the normalized image, and a reagent reaction is detected by performing image recognition on the extracted color component image. The above described embodiments may be combined as necessary.

The above described embodiments make it possible to convert images of various types of meters captured under various lighting conditions into images suitable for recognition processing. According to an embodiment, color markers are attached to the periphery of a recognition object, the markers in a captured image of the recognition object are automatically detected through an image recognition process, and the captured image is converted and optimized based on the detected markers. This makes it possible to accurately recognize a recognition object without being affected by, for example, a distance or an angle at which the recognition object is captured. Also, the above described embodiments make it possible to recognize information such as characters and values in an image that is captured by a user (operator) using any imaging device at any location and time.

In the above described embodiments, multiple channel images of color components are generated from one image, an appropriate image is selected from the multiple channels images, and an optimization process is performed on the selected image. Thus, the above described embodiments make it possible to exclude images that are difficult to recognize from processing targets, and thereby make it possible to reduce processing time. This in turn makes it possible to reduce the computational load for image processing, and makes it possible to reduce processing time even when a low-performance computer is used.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing apparatus, comprising:
a processor that executes a process including
converting an input image into multiple types of images based on values of pixels in the input image, and
selecting at least one image from the multiple types of images based on luminance information of the multiple types of images.

2. The image processing apparatus as claimed in claim 1, wherein the process further includes
obtaining differences between values of R, G, and B components of each pixel in a line set in the input image, and determining a largest difference in the obtained differences;
determining a number of pixels in the line the largest difference of which is greater than a predetermined threshold; and
determining, based on the determined number of pixels, whether to include an H-component image, an S-component image, and an I-component image in the multiple types of images to be obtained by converting the input image in addition to an R-component image, a G-component image, and a B-component image.

3. The image processing apparatus as claimed in claim 1, wherein the process further includes
obtaining luminance values of R, G, and B components of each pixel in a line set in the input image;
for each of R, G, and B component images of the input image, determining a number of pixels whose luminance values are greater than a predetermined threshold; and
determining, based on the determined number of pixels, whether to exclude each of the R, G, and B component images from the multiple types of images to be obtained by converting the input image.

4. The image processing apparatus as claimed in claim 2, wherein a number and positions of lines set in the input image are determined based on at least one of a type of a recognition object in the input image, a captured time of the input image, a captured location of the input image, and an imaging parameter used to capture the input image.

5. The image processing apparatus as claimed in claim 3, wherein a number and positions of lines set in the input image are determined based on at least one of a type of a recognition object in the input image, a captured time of the input image, a captured location of the input image, and an imaging parameter used to capture the input image.

6. The image processing apparatus as claimed in claim 1, wherein the process further includes
detecting positions of markers in the input image; and
performing projective transformation on an image area defined by the detected positions of the markers to obtain a projectively-transformed image,
wherein the converting is performed on the projectively-transformed image.

7. The image processing apparatus as claimed in claim 1, wherein the process further includes
recognizing information in a recognition object in the selected image, the information including at least one of a character, a value, a symbol, and a shape in the recognition object.

8. A method performed by an image processing apparatus, the method comprising:
converting an input image into multiple types of images based on values of pixels in the input image; and
selecting at least one image from the multiple types of images based on luminance information of the multiple types of images.

9. A non-transitory computer-readable storage medium storing a program that causes a computer to execute a process, the process comprising:
converting an input image into multiple types of images based on values of pixels in the input image; and
selecting at least one image from the multiple types of images based on luminance information of the multiple types of images.
